(19) United States
(12) Patent Application Publication
(10) Pub. No.: US 2010/0245122 A1
(43) Pub. Date: Sep. 30, 2010

(54) Unit Configuration/Reactivation Through VDU Services

(75) Inventors: Jessica L. Haralson, Lake Orion, MI (US); Steven P. Schwinke, Plymouth, MI (US)

Correspondence Address: Leydig, Voit & Mayer, Ltd., Two Prudential Plaza, Suite 4900, 180 North Stetson Avenue, Chicago, IL, 60601-6731, US

(73) Assignee: General Motors Corporation, Detroit, MI (US)

(21) Appl. No.: 12/414,911

(22) Filed: Mar. 31, 2009

(51) Int. Cl. G08B 21/00; H04M 3/00

(52) U.S. Cl. 340/870.16; 455/420

(57) ABSTRACT

A system and method for activating an inactive telematics unit provides a group of communications functions to the telematics unit. Initially, a call is received at a call center from a user of the telematics unit, through which subscriber information is obtained. An account data set is created at the call center based on the subscriber information and the call center advisor sets an activation trigger in the telematics unit. When the trigger condition occurs, the telematics unit places a VDU call to the call center. The call center then automatically activates and configures the telematics unit via the VDU call to provide the group of one or more communications functions.

### BACKGROUND OF THE INVENTION

Today's automobile is a very complex arrangement of interrelated parts and systems. Facilities are provided to execute the transportation functions required of the vehicle (engine, transmission, etc.). However, it is common for a vehicle to further include additional subsystems to serve requirements related to user comfort, safety and/or entertainment. For example, most vehicles comprise an environmental control system (e.g., A/C, heat, seat and steering wheel heaters, etc.) and some type of entertainment system (e.g., radio, CD player, and/or DVD player, etc.).

One important subsystem that serves as a navigation tool, an entertainment tool, and a safety device is an onboard telematics unit, such as that produced and marketed by OnStar. Such devices have been commercially quite successful and very well-received, and are now standard equipment in most high-quality vehicles. Given, the length of time that such devices have been in use, there are many instances today of a vehicle changing hands, i.e., from user to dealer, user to user, or dealer to user, with the telematics unit still installed and included as part of the transferred vehicle. Indeed, the inclusion of the telematics unit is often an explicit or implicit condition of the sale or transfer.

In light of this, it has long been a challenge, unsolved until the invention described herein, to quickly and efficiently reactivate or reconfigure the telematics unit after such a transfer.

### BRIEF SUMMARY OF THE INVENTION

The invention provides a system and method for activating an inactive telematics unit and providing a group of communications functions to the telematics unit. Initially, a call is received at a call center from a user of the telematics unit, through which subscriber information is obtained. An account data set is created at the call center based on the subscriber information and the call center advisor sets an activation trigger in the telematics unit. When the trigger condition occurs, the telematics unit places a VDU call to the call center. The call center then automatically activates and configures the telematics unit via the VDU call to provide the group of one or more communications functions.

Other objects and advantages of the invention will become apparent upon reading the following detailed description and upon reference to the drawings.

### BRIEF DESCRIPTION OF THE SEVERAL VIEWS OF THE DRAWINGS

FIG. 1 is a schematic diagram of an operating environment for a mobile vehicle communication system;

FIG. 2 is a more detailed schematic diagram of a telematics system within a mobile vehicle;

FIG. 3 is a flow chart illustrating a process of telematics unit activation or reactivation according to an example of the invention; and

FIG. 4 is a data diagram showing the multiple stages and locations of the reactivation process according to an embodiment of the invention.

### DETAILED DESCRIPTION OF THE INVENTION

Before describing the invention in detail, an exemplary environment in which the invention may operate will be described. It will be appreciated that the described environment is for purposes of illustration only, and does not imply any limitation regarding the use of other environments to practice the invention.

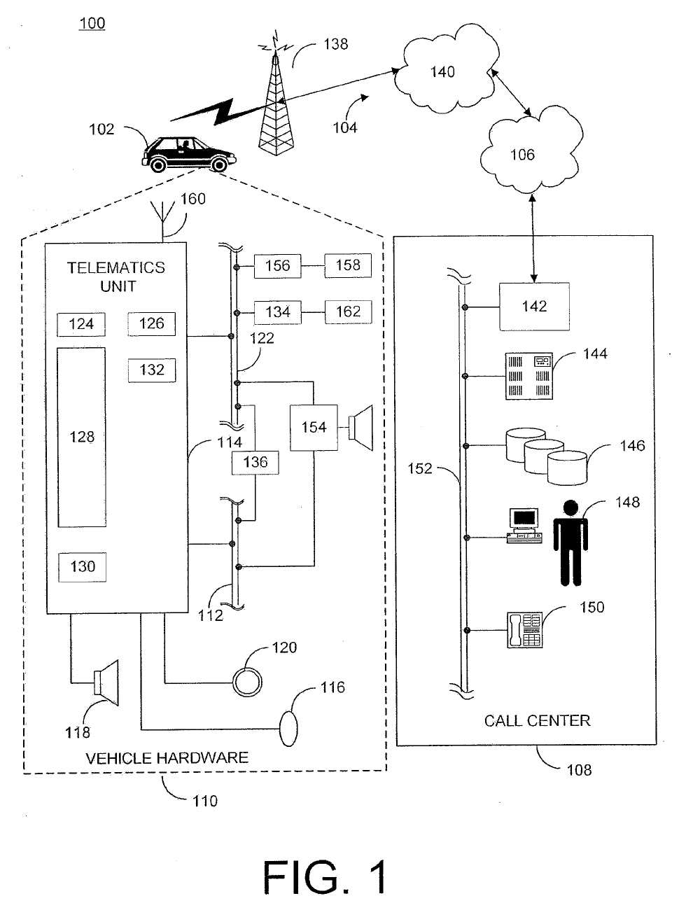

With reference to FIG. 1 there is shown an example of a communication system 100 that may be used with the present method and generally includes a vehicle 102, a wireless carrier system 104, a land network 106 and a call center 108. It should be appreciated that the overall architecture, setup and operation, as well as the individual components of a system such as that shown here are generally known in the art. Thus, the following paragraphs simply provide a brief overview of one such exemplary information system 100; however, other systems not shown here could employ the present method as well.

Vehicle 102 is preferably a mobile vehicle such as a motorcycle, car, truck, recreational vehicle (RV), boat, plane, etc., and is equipped with suitable hardware and software that enables it to communicate over system 100. Some of the vehicle hardware 110 is shown generally in FIG. 1 including a telematics unit 114, a microphone 116, a speaker 118 and buttons and/or controls 120 connected to the telematics unit 114. Operatively coupled to the telematics unit 114 is a network connection or vehicle bus 122. Examples of suitable network connections include a controller area network (CAN), a media oriented system transfer (MOST), a local interconnection network (LIN), an Ethernet, and other appropriate connections such as those that conform with known ISO, SAE, and IEEE standards and specifications, to name a few.

The telematics unit 114 is an onboard device that provides a variety of services through its communication with the call center 108, and generally includes an electronic processing device 128 one or more types of electronic memory 130, a cellular chipset/component 124, a wireless modem 126, a dual antenna 160 and a navigation unit containing a GPS chipset/component 132. In one example, the wireless modem 126 is comprised of a computer program and/or set of software routines executing within processing device 128. The cellular chipset/component 124 and the wireless modem 126 may be called the network access device (NAD) 180 of the telematics unit.

The telematics unit 114 provides too many services to list them all, but several examples include: turn-by-turn directions and other navigation-related services provided in conjunction with the GPS based chipset/component 132; airbag deployment notification and other emergency or roadside assistance-related services provided in connection with various crash and or collision sensor interface modules 156 and sensors 158 located throughout the vehicle. Infotainment-related services where music, Web pages, movies, television programs, video games and/or other content is downloaded by an infotainment center 136 operatively connected to the telematics unit 114 via vehicle bus 122 and audio bus 112. In one example, downloaded content is stored for current or later playback.

Again, the above-listed services are by no means an exhaustive list of all the capabilities of telematics unit 114, as should be appreciated by those skilled in the art, but are simply an illustration of some of the services that the telematics unit is capable of offering. It is anticipated that telematics unit 114 include a number of known components in addition to those listed above.

Vehicle communications preferably use radio transmissions to establish a voice channel with wireless carrier system 104 so that both voice and data transmissions can be sent and received over the voice channel. Vehicle communications are enabled via the cellular chipset/component 124 for voice communications and a wireless modem 126 for data transmission. In order to enable successful data transmission over the voice channel, wireless modem 126 applies some type of encoding or modulation to convert the digital data so that it can communicate through a vocoder or speech codec incorporated in the cellular chipset/component 124. Any suitable encoding or modulation technique that provides an acceptable data rate and bit error can be used with the present method. Dual mode antenna 160 services the GPS chipset/component and the cellular chipset/component.

Microphone 116 provides the driver or other vehicle occupant with a means for inputting verbal or other auditory commands, and can be equipped with an embedded voice processing unit utilizing a human/machine interface (HMI) technology known in the art. Conversely, speaker 118 provides verbal output to the vehicle occupants and can be either a stand-alone speaker specifically dedicated for use with the telematics unit 114 or can be part of a vehicle audio component 154. In either event, microphone 116 and speaker 118 enable vehicle hardware 110 and call center 108 to communicate with the occupants through audible speech. The vehicle hardware also includes one or more buttons or controls 120 for enabling a vehicle occupant to activate or engage one or more of the vehicle hardware components 110. For example, one of the buttons 120 can be an electronic push button used to initiate voice communication with call center 108 (whether it be a live advisor 148 or an automated call response system). In another example, one of the buttons 120 can be used to initiate emergency services.

The audio component 154 is operatively connected to the vehicle bus 122 and the audio bus 112. The audio component 154 receives analog information, rendering it as sound, via the audio bus 112. Digital information is received via the vehicle bus 122. The audio component 154 provides AM and FM radio, CD, DVD, and multimedia functionality independent of the infotainment center 136. Audio component 154 may contain a speaker system, or may utilize speaker 118 via arbitration on vehicle bus 122 and/or audio bus 112.

The vehicle crash and/or collision detection sensor interface 156 are operatively connected to the vehicle bus 122. The crash sensors 158 provide information to the telematics unit via the crash and/or collision detection sensor interface 156 regarding the severity of a vehicle collision, such as the angle of impact and the amount of force sustained.

Vehicle sensors 162, connected to various sensor interface modules 134 are operatively connected to the vehicle bus 122. Example vehicle sensors include but are not limited to gyroscopes, accelerometers, magnetometers, emission detection and/or control sensors, and the like. Example sensor interface modules 134 include power train control, climate control, and body control, to name but a few.

Wireless carrier system 104 is preferably a cellular telephone system or any other suitable wireless system that transmits signals between the vehicle hardware 110 and land network 106. According to an example, wireless carrier system 104 includes one or more cell towers 138, base stations and/or mobile switching centers (MSCs) 140, as well as any other networking components required to connect the wireless system 104 with land network 106. A component in the mobile switching center may include a remote data server 180. As appreciated by those skilled in the art, various cell tower/base station/MSC arrangements are possible and could be used with wireless system 104. For example, a base station and a cell tower could be co-located at the same site or they could be remotely located, and a single base station could be coupled to various cell towers or various base stations could be coupled with a single MSC, to but a few of the possible arrangements. Preferably, a speech codec or vocoder is incorporated in one or more of the base stations, but depending on the particular architecture of the wireless network, it could be incorporated within a Mobile Switching Center or some other network components as well.

Land network 106 can be a conventional land-based telecommunications network that is connected to one or more landline telephones and connects wireless carrier network 104 to call center 108. For example, land network 106 can include a public switched telephone network (PSTN) and/or an Internet protocol (IP) network, as is appreciated by those skilled in the art. Of course, one or more segments of the land network 106 can be implemented in the form of a standard wired network, a fiber or other optical network, a cable network, other wireless networks such as wireless local networks (WLANs) or networks providing broadband wireless access (BWA), or any combination thereof.

Call Center (OCC) 108 is designed to provide the vehicle hardware 110 with a number of different system back-end functions and, according to the example shown here, generally includes one or more switches 142, servers 144, databases 146, live advisors 148, as well as a variety of other telecommunication and computer equipment 150 that is known to those skilled in the art. These various call center components are preferably coupled to one another via a network connection or bus 152, such as the one previously described in connection with the vehicle hardware 110. Switch 142, which can be a private branch exchange (PBX) switch, routes incoming signals so that voice transmissions are usually sent to either the live advisor 148 or an automated response system, and data transmissions are passed on to a modem or other piece of equipment 150 for demodulation and further signal processing.

The modem 150 preferably includes an encoder, as previously explained, and can be connected to various devices such as a server 144 and database 146. For example, database 146 could be designed to store subscriber profile records, subscriber behavioral patterns, or any other pertinent subscriber information. Although the illustrated example has been described as it would be used in conjunction with a manned call center 108, it will be appreciated that the call center 108 can be any central or remote facility, manned or unmanned, mobile or fixed, to or from which it is desirable to exchange voice and data.

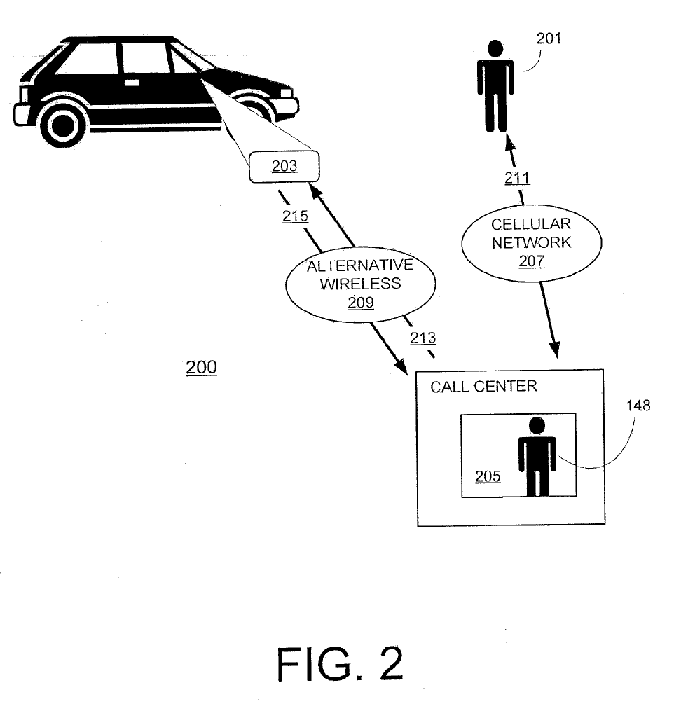

FIG. 2 is a data flow diagram illustrating schematically a series of data transactions according to an embodiment of the invention. In particular, this figure illustrates one way in which reconfiguration or reactivation of a telematics unit may be executed in one example. Typically, reactivation of a telematics unit requires a telephone call between the user or other personnel associated with the vehicle (herein collectively referred to as “the user”) and a live advisor.

During the session, the user conveys information to the advisor, who enters the information at a terminal or other input facility, causing a reactivation of the unit. This process may take a significant amount of time, and indeed, on average has been found to take between 5 and 7 minutes. This is an inconvenience for the user, and also represents a substantial cost in terms of personnel time for the live advisor participation as well as other costs such as phone and equipment costs.

In an embodiment of the invention, the user involvement, live advisor participation, and phone and other costs are substantially reduced by coordinating the reactivation process between a first phase and a second phase. The first phase, or manual phase, involves a telephonic or other communication from the user to the live advisor or other facility for receiving information and inputting it to the wireless provider system. The second phase, referred to as the autonomous phase, entails a communication autonomously originating from the remote telematics unit and terminating at the service provider, and does not involve user participation or live advisor participation.

The system architecture and data flows 200 shown in FIG. 2 clarify the data transactions involved to enable/re-enable a telematics unit. The illustrated entities include the user 201, the telematics unit 203 associated with a vehicle, the call center 205, including operator 148, a cellular network 207, and an alternate wireless network 209, which in an embodiment of the invention is also the cellular network 207 or other cellular network. The illustrated system 200 also shows data transactions 211, 213, and 215, which will be explained in overview here, and then in greater detail below by way of other figures.

In overview, the provisioning advisor receives a call from the user 201 to the call center 205 requesting activation of the telematics unit 203. In an embodiment of the invention, the call is from a telephone associated with the user 201, e.g., a cellular call 211 over the cellular network 207. In another embodiment of the invention, the call originates as a hands-free call from within the vehicle via a key press by the user at the non-configured or deactivated telematics unit 203, resulting in connection or data transfer session 211 from the user to the call center 205, and the advisor 148 therein.

The advisor 148 begins to process the enrollment request by soliciting, receiving and inputting relevant information from the user 201 over the connection 211. Such information may include, for example, user name, user vehicle type and location, desired set of features (e.g., emergency-only assistance, navigation guidance, etc.), and so on. At that point, the involvement of the user 201 is at and end, and the advisor 148 or an automatic facility then sets a vehicle data upload trigger in the telematics unit 203 via communication 213 that will force the telematics unit 203 to call back into the service provider, e.g., at the call center 108, via communication 215, to complete provisioning and processing related to the activation request.

In an embodiment of the invention, the call back from the telematics unit 203 to the call center 108 is caused by the occurrence of a predetermined trigger condition (i.e., occurrence of one or more ignition cycles, expiration of a predetermined period of time, attainment of a mileage condition, etc.) and the configuration will then take place without requiring the participation of the customer 201 or the advisor 148. However, in an embodiment of the invention, the customer 201 is notified if the attempt to reactivate or reconfigure the telematics unit 203 fails.

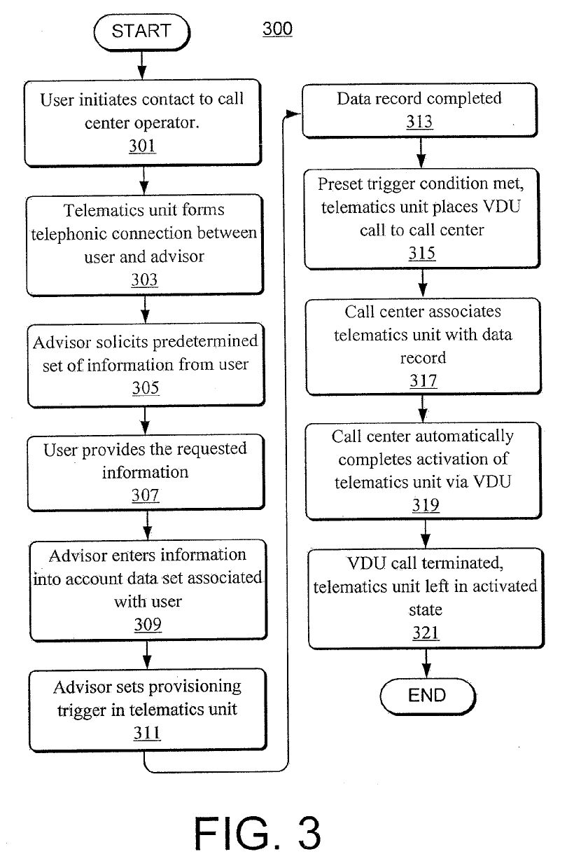

The process by which the illustrated elements facilitate telematics unit configuration or reactivation is illustrated in greater detail via the flow chart of FIG. 3. In particular, FIG. 3 illustrates a flowchart 300 of a process, according to an embodiment of the invention, for configuring or reactivating the telematics unit 203. Initially, the user 201 contacts the call center operator. In an embodiment of the invention, this is executed at stage 301 of the process 300 when the user presses a particular button (e.g., the blue OnStar button) or enters a particular command at the telematics unit 203. At stage 303 of the process 300, the telematics unit 203 contacts the call center 205 and reaches the advisor 148, forming a telephonic connection between the user 201 and the advisor 148.

After the connection between the user 201 and the advisor 148 is established, the advisor 148 solicits a predetermined set of information from the user 201 at stage 305, and the user provides the requested information at stage 307. As noted above, such information may include, for example, user name, user vehicle type and location, desired set of features (e.g., emergency-only assistance, navigation guidance, etc.), and so on. At stage 309, the advisor enters the provided information into an account data set associated with the user of interest. In this stage, the advisor 148 may also launch the request for a mobile dialing number (MDN), and may also queue minutes or other options if the user 201 wishes to purchase cellular minutes and/or the other options.

Subsequently, at stage 311, the advisor sets a provisioning trigger in the telematics unit associated with the user. As noted above, the provisioning trigger may be the occurrence of one or more ignition cycles, the expiration of a predetermined period of time, attainment of a mileage condition, or other suitable predefined time or state. The voice call between the user 201 and the advisor 148 may be terminated before or after stage 311.

At stage 313, the data record started by the advisor 148 is completed, i.e., the requested MDN and other information is received and added to the record associated with the calling telematics unit 203. The MDN is selected in any suitable fashion, e.g., by basing the MDN on the geographical garaged address of the vehicle 102.

At stage 315, when the preset trigger condition is met via action of the user 201 and/or vehicle 102 and/or the passage of time depending upon the exact trigger condition set, the second portion of the activation process 300 is begun. In particular, the occurrence of the trigger condition causes the telematics unit 203 to place a vehicle data upload (VDU) call to the call center 205 at stage 315 of process 300. Upon receiving the VDU call, the call center 205 associates the telematics unit 203 with an existing data record in stage 317. In an embodiment of the invention, the data record associated with the telematics unit 203 is the data set created in stage 309 by the live advisor 148.

At stage 319, the call center 205 automatically completes the activation of the telematics unit 203 via the VDU session that was begun at stage 315. When the steps on the telematics unit 203 needed for activation are complete, the VDU call is terminated at stage 321, and the telematics unit 203 is left in an activated state as desired.

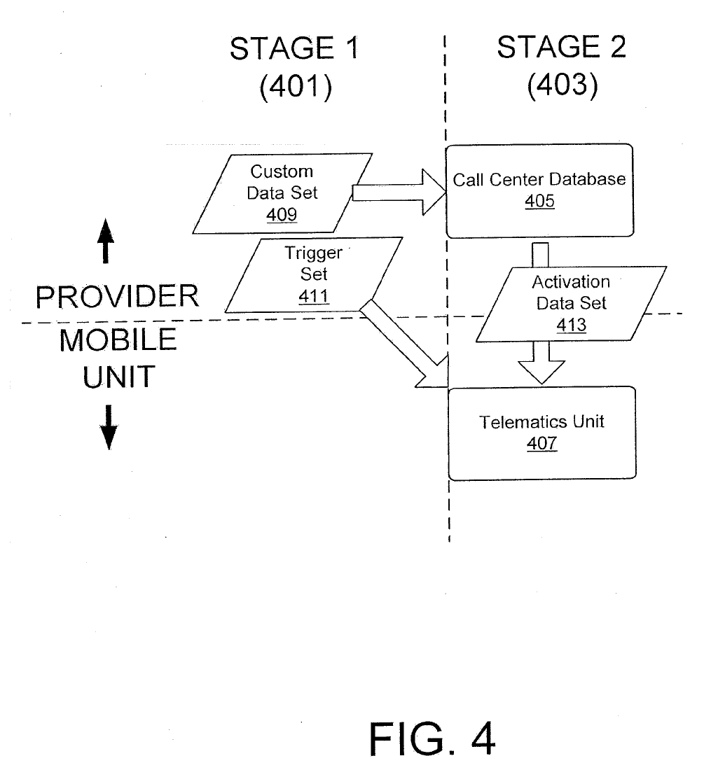

FIG. 4 is a simplified schematic summarizing the 2-stage geographically dispersed nature of the activation process 300. As can be seen, data transfers take place both in a first stage 401 and a second stage 403, and in addition, certain responsive actions take place in the second stage 403. In particular, the custom data set 409 is transferred to the call center database 405 in the first stage 401. This data set identifies the user 201 and telematics unit 203, and may also contain user-selected preferences and options for activation. In addition, the trigger set 411, or trigger criteria, and associated logic for initiating the VDU session, are transferred to the telematics unit 407 in the first stage 401. In the second stage 403, the telematics unit 203 initiates a VDU call to the provider based on the trigger set 411 and other information, and receives an activation data set 413, which may include all or part of the custom data set 409, during activation.

It will be appreciated that the foregoing methods and implementations for bifurcated telematics activation are merely examples, and that these illustrate a preferred technique for telematics activation. However, it is contemplated that other implementations of the invention may differ in detail from foregoing examples. As noted earlier, all references to the invention are intended to reference the particular example of the invention being discussed at that point and are not intended to imply any limitation as to the scope of the invention more generally. All language of distinction and disparagement with respect to certain features is intended to indicate a lack of preference for those features, but not to exclude such from the scope of the invention entirely unless otherwise indicated.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. A method of activating an inactive telematics unit to provide a group of one or more communications functions to the telematics unit, the method comprising:
receiving a first call at a call center from a user of the telematics unit;
receiving subscriber information at the call center from the user of the telematics unit;
creating an account data set at the call center based on the subscriber information and setting, from the call center, an activation trigger in the telematics unit;
terminating the first call;
receiving a VDU call at the call center from the telematics unit pursuant to the activation trigger; and
from the call center via the VDU call, activating and configuring the telematics unit to provide the group of one or more communications functions.

2. The method according to claim 1, wherein the first call is made by the user via the telematics unit.

3. The method according to claim 1, wherein the subscriber information includes at least an identification of a desired number of cellular minutes available through the telematics unit.

4. The method according to claim 1, further comprising requesting a MDN for the telematics unit.

5. The method according to claim 4, further comprising receiving the MDN for the telematics unit prior to receiving the VDU call at the call center from the telematics unit pursuant to the activation trigger.

6. The method according to claim 5, wherein the step of activating and configuring the telematics unit to provide the group of one or more communications functions further comprises providing the MDN to the telematics unit.

7. The method according to claim 1, wherein the activation trigger includes at least one of: an identification of a number of ignition cycles, an identification of a predetermined period of time, and an identification of a mileage condition.

8. A computer-readable medium having thereon computer-executable instructions for activating an inactive telematics unit to provide a group of one or more communications functions to the telematics unit, the computer-executable instructions comprising:
instructions for receiving a first call at a call center from a user of the telematics unit;
instructions for receiving subscriber information at the call center from the user of the telematics unit;
instructions for creating an account data set at the call center based on the subscriber information and setting, from the call center, an activation trigger in the telematics unit;
instructions for terminating the first call;
instructions for receiving a VDU call at the call center from the telematics unit pursuant to the activation trigger; and
instructions for activating and configuring the telematics unit from the call center via the VDU call to provide the group of one or more communications functions.

9. The computer-readable medium according to claim 8, wherein the first call is made by the user via the telematics unit.

10. The computer-readable medium according to claim 8, wherein the subscriber information includes at least an identification of a desired number of cellular minutes available through the telematics unit.

11. The computer-readable medium according to claim 8, wherein the computer-executable instructions further comprise instructions for requesting a MDN for the telematics unit.

12. The computer-readable medium according to claim 11, wherein the computer-executable instructions further comprise instructions for receiving the MDN for the telematics unit prior to receiving the VDU call at the call center from the telematics unit pursuant to the activation trigger.

13. The computer-readable medium according to claim 12, wherein the instructions for activating and configuring the telematics unit to provide the group of one or more communications functions further comprises instructions for providing the MDN to the telematics unit.

14. The computer-readable medium according to claim 8, wherein the activation trigger includes at least one of: an identification of a number of ignition cycles, an identification of a predetermined period of time, and an identification of a mileage condition.

15. A system for activating an inactive telematics unit to provide a group of one or more communications functions to the telematics unit, the system comprising:
a call center database;
a custom data set associated with a user of the telematics unit;
a trigger set describing a trigger condition; and
an activation data set at least partially based on the custom data set, wherein the custom data set is stored in the call center data base, and the trigger data set is stored in the telematics unit, and wherein occurrence of the trigger condition causes the telematics unit to place a VDU call to the call center, whereupon the activation data set is provided to the telematics unit and the unit is thereby activated attain the group of one or more communications functions.

16. The system for activating an inactive telematics unit according to claim 15, wherein the custom data set associated with a user of the telematics unit is created based on information provided telephonically by the user.

17. The system for activating an inactive telematics unit according to claim 15, wherein the custom data set includes at least an identification of a desired number of cellular minutes available through the telematics unit.

18. The system for activating an inactive telematics unit according to claim 15, wherein the custom data set includes a MDN for the telematics unit.

19. The system for activating an inactive telematics unit according to claim 15, wherein the trigger condition includes at least one of: a number of ignition cycles, a predetermined period of time, and a mileage condition.

20. The system for activating an inactive telematics unit according to claim 15, wherein the information provided telephonically by the user is received via a different connection mechanism than that used for the VDU call.
